(19) United States
(12) Patent Application Publication
(10) Pub. No.: US 2015/0024172 A1
(43) Pub. Date: Jan. 22, 2015

(54) Migration Resistant Single Faced Corrugated Loose Fill Packaging Material

(71) Applicant: John Pollock, Rantoul, KS (US)

(72) Inventor: John Pollock, Rantoul, KS (US)

(21) Appl. No.: 13/947,563

(22) Filed: Jul. 22, 2013

(51) Int. Cl. B32B 3/28; B31D 5/00

(52) U.S. Cl. CPC B32B 3/28; B31D 5/0039; B31D 2205/0041; B31D 2205/0058; B32B 2250/02; B32B 2553/02; B32B 2307/56
USPC 428/182; 83/39

(57) ABSTRACT

A migration resistant loose fill packaging material according to the present invention includes a plurality of single faced corrugated strips. Each corrugated strip includes a single liner member having an elongate and generally planar configuration, the base member having an upper surface and an opposed lower surface. Each corrugated strip also includes a corrugation portion having a plurality of connected fluted elements bonded to the upper surface of the single liner member.

### BACKGROUND OF THE INVENTION

This invention relates to packaging material and, more particularly, to a loose fill packaging material consisting of a plurality of single faced corrugated members that are configured to interlock in a manner that holds an article securely and inhibit migration of a packaged article during shipping.

Loose fill packaging material has been used for many years to support and protect goods that have the potential to be damaged or broken during shipping. The outer shipping container may be substantially filled with the loose packing material, the article being shipped being placed into the container, and then more packing material inserted around the article. The packaging material is intended to prevent breakage or damage by absorbing the shocks or impacts that may be experienced when the container is handled roughly, when other containers slide into the container, or just from repeated vibration during shipping.

Various types of loose fill packaging have been used. Discrete units made of a polystyrene foam material, also referred to as “peanuts” have been utilized because of their supposed shock-absorbent properties. Further, double side corrugated cardboard, fiberboard, or paper materials have been utilized as loose fill packaging material as a more environmentally friendly and better performing alternative to foam beads.

Although presumably effective for their intended purposes, the existing forms of loose fill packaging do not effectively prevent or sufficiently inhibit the migration or shifting of position of the goods packaged in a container that results in breakage or damage to the shipped goods. For instance, cargo such as eggs, bottles of liquid, and other fragile goods have a high risk of damage if the loose fill packaging allows them to migrate to the bottom of the shipping container where they impact other items within the container or are exposed to impact forces from outside the container.

Therefore, it would be desirable to have a loose fill packaging material that forms a tight interlocked network around packaged article(s) so as to inhibit migration of the packaged article(s). Further, it would be desirable to have a loose fill packaging material that includes a plurality of single faced corrugated strips that are lightweight, shock absorbent, and are clean. In addition, it would be desirable to have a loose fill packaging material that is absorbent, natural and biodegradable, and static free.

### SUMMARY OF THE INVENTION

A migration resistant loose fill packaging material according to the present invention includes a plurality of single faced corrugated strips. Each corrugated strip includes a single liner member having an elongate and generally planar configuration, the base member having an upper surface and an opposed lower surface. Each corrugated strip also includes a corrugation portion having a plurality of connected fluted elements bonded to the upper surface of the single liner member.

Each single faced corrugated strip is generally flexible and interconnects with other strips to form a generally tight network that supports items positioned thereon. The network of strips prevent items from shifting in transit, does not settle or crumble, and effectively protects from damage that may otherwise result from moving into one another or to the bottom of a shipping container. In addition, each corrugated strip is clean, environmentally friendly, and biodegradable.

The single faced packaging material provides unexpected successful results. Not only does this packaging material provide resilient and strong support for packaged articles, it provides exceptional interconnectivity that resists and prevents undesired migration of the packaged article. As will be discussed later, currently existing packaging products having some similarities of construction do not exhibit the successful results of the present invention.

Therefore, a general object of this invention is to provide a loose fill packaging material that holds an article securely in shipping and prevents migration of the article within the shipping container.

Another object of this invention is to provide a loose fill packaging material, as aforesaid, that includes a plurality of discreet single faced corrugated members that interconnect with one another so as to prevent an article from migrating relative to the loose fill packaging material.

Still another object of this invention is to provide a loose fill packaging material, as aforesaid, that absorbs impact forces so as to protect an article in shipping.

Yet another object of this invention is to provide a loose fill packaging material, as aforesaid, having a plurality of strips that maintain random positioning with regard to other strips so that the packaging elements do not just stack or nest.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a single faced corrugated strip of a loose fill packaging material according to a preferred embodiment of the present invention;

FIG. 2 is an isolated view on an enlarged scale taken from a portion of FIG. 1;

FIG. 3 is a perspective view of a single faced corrugated strip of a loose fill packaging material taken from another angle;

FIG. 4 is an exploded view of the corrugated strip as in FIG. 1;

FIG. 5 is a perspective view of a single faced corrugated strip of a loose fill packaging material according to another embodiment of the present invention;

FIG. 6a is front view of a plurality of single faced corrugated strips interconnecting with one another;

FIG. 6b is an isolated view on an enlarged scale taken from a portion of FIG. 6a;

FIG. 7 is a block diagram illustrating a method for making and using the loose fill packaging material according to the present invention;

FIG. 8a is another perspective view of the single faced corrugated strip of FIG. 1 illustrating a proportion of a width of the strip and a distance between adjacent fluted elements;

FIG. 8b is another perspective view of the single faced corrugated strip of FIG. 8a with quantitative values added;

FIG. 9a is another perspective view of the single faced corrugated strip of FIG. 1 illustrating a proportion of a width of the strip and a distance between adjacent fluted elements; and

FIG. 9b is another perspective view of the single faced corrugated strip of FIG. 8a with quantitative values added.

### DESCRIPTION OF THE PREFERRED EMBODIMENT

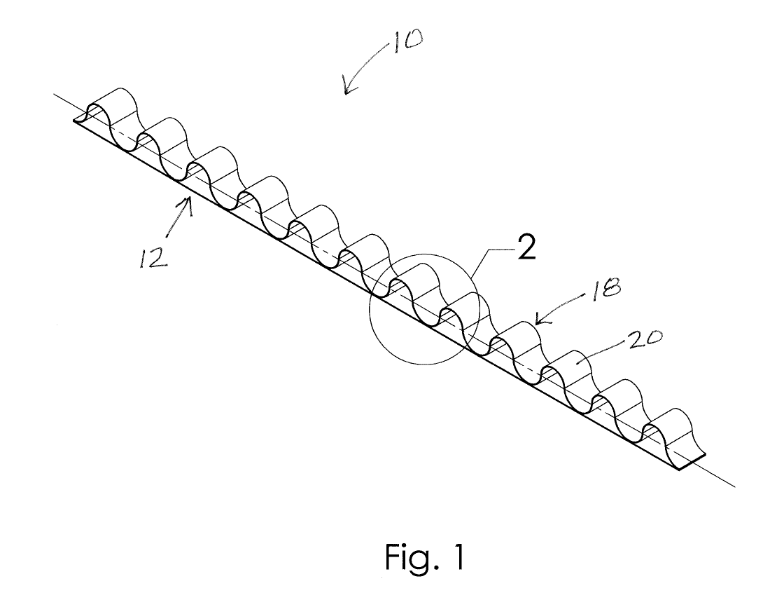

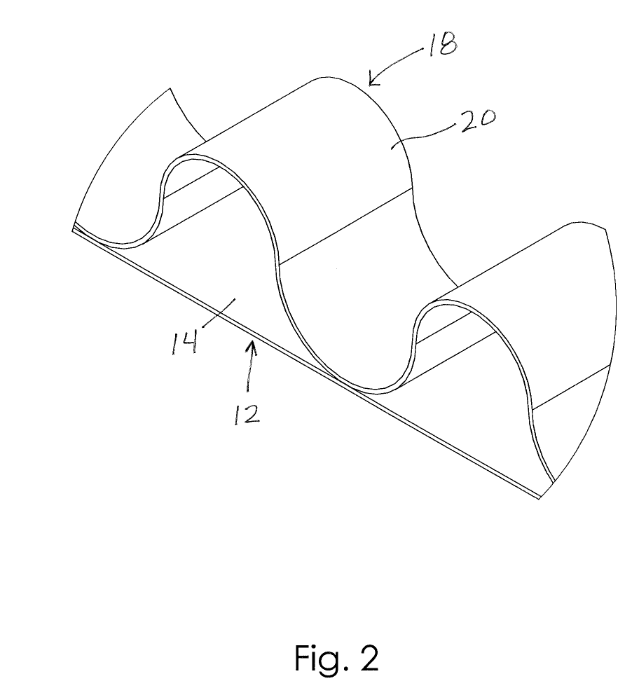

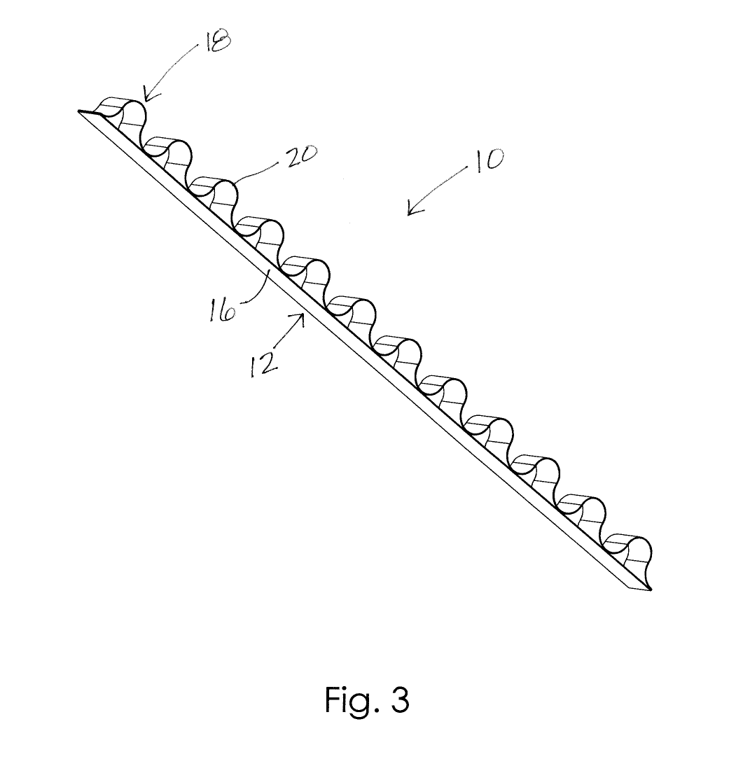

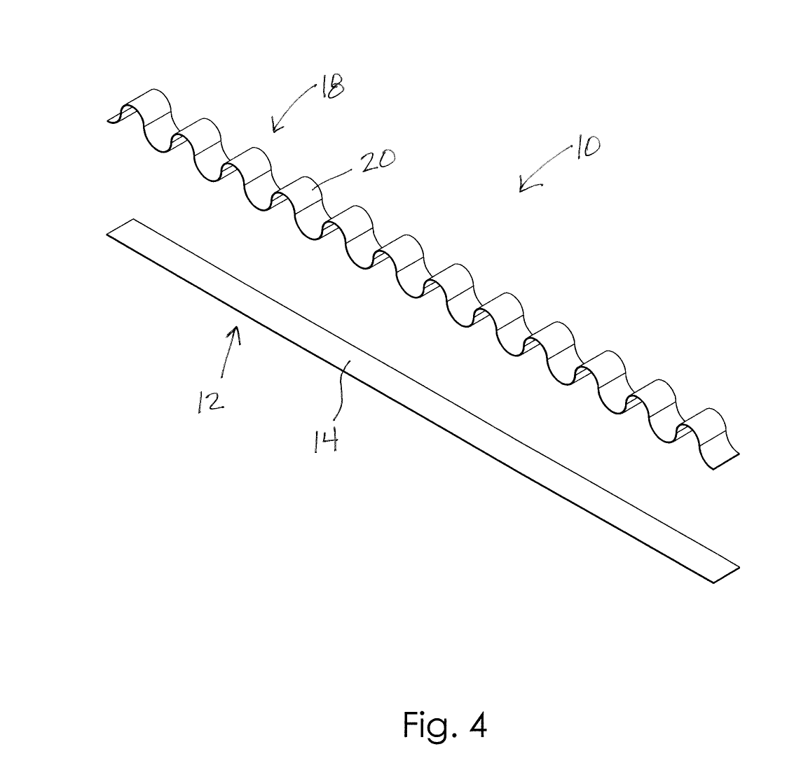

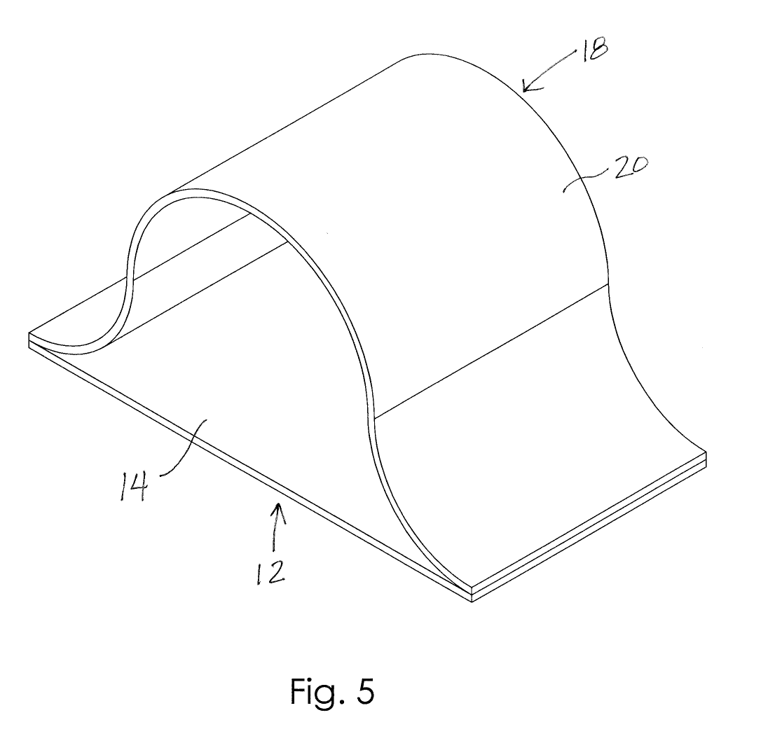

A loose fill packaging material according to a preferred embodiment of the present invention will now be described with reference to FIGS. 1 to 7 of the accompanying drawings.

FIG. 1 illustrates a single faced corrugated strip 10 that has been cut from an entire sheet of single faced corrugated material. A plurality of single faced corrugated strips 10 may be cut from a sheet thereof as will be described later in more detail. The single faced corrugated material may be formed from recycled or virgin paper material. Each single faced corrugated strip 10 includes a single liner member 12 (also referred to as a liner board) having an elongate and generally planar configuration. Each single faced corrugated strip 10 is mildly flexible yet resilient. In other words, a plurality of strips will bend and flex somewhat when an item is placed atop the plurality of strips—such as in packaging—yet the strips may return to their normally generally linear configuration when the item is removed.

Preferably, each liner member 12 has a linear configuration and a generally rectangular shape although other configurations may also be suitable. In one embodiment, each corrugated strip 10 may include a length of about 102 mm and a width of about 4 mm.

As will further described below, the width of a corrugated strip is preferably less than or equal to the distance between any two adjacent fluted elements 20.

Each liner member 12 has opposed upper 14 and lower 16 surfaces, the lower surface 16 having a planar smooth texture. Preferably, each liner member 12 has a semi-rigid/semi-flexible construction so that it normally maintains a straight, unbent configuration. It is understood, of course, that each single faced corrugated strip 10 may be flexible and bendable as it is packed into a shipping container around articles for shipment. Each strip 10 may also be cut or torn.

Each single faced corrugated strip 10 also includes a corrugated portion 18 attached to an upper surface 14 of a respective liner member 12. The corrugated portion 18 may be bonded to the liner member 12. The corrugated portion 18 includes a plurality of adjacent fluted elements 20. Each fluted element 20 has a generally inverted U-shaped configuration relative to the liner member 12 to which it is bonded and having sloped sides. Accordingly, one side of a single faced corrugated strip 10 presents a wavy configuration. It is understood that each fluted element 20 may, in some embodiments, include an inverted V-shaped configuration or a strict inverted u-shaped configuration not having sloped sides. In one embodiment, in contrast to the generally elongate strip described above, a single faced corrugated strip 10 may include a shortened configuration having a truncated linear member 12 with only a single corrugated portion 18. Corrugated material is often classified by flute sizes or number of flutes per linear foot. Common flute sizes are classified as “A,” “B,” “C,” “jumbo,” and so on. The preferred sizes of flutes in the present application are A, B, C, or jumbo.

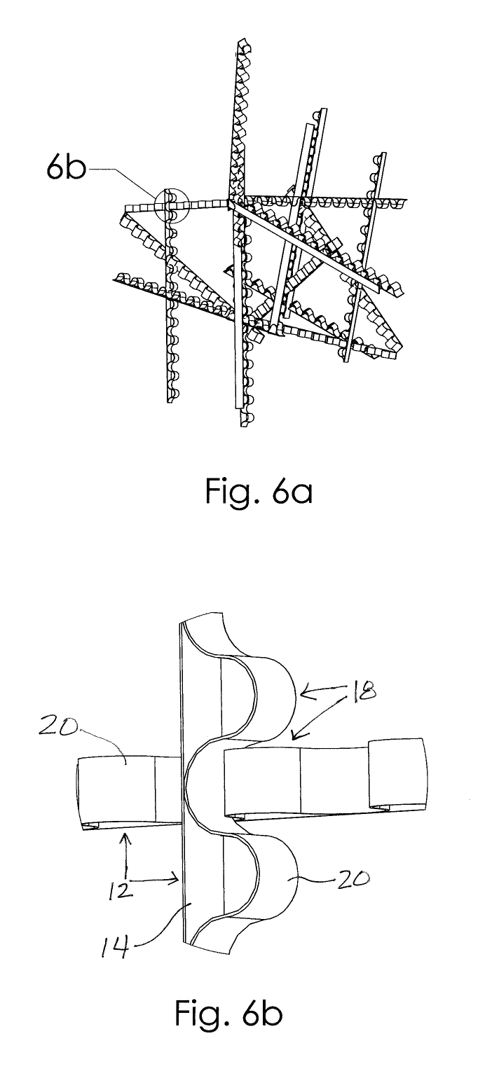

A strip 10 of corrugated material defines an imaginary longitudinal axis. Each fluted element 20 defines opposed open ends. In fact, each fluted element 20 defines an open interior area. The open ends are situated perpendicular to the imaginary longitudinal axis. The configuration of the single faced corrugated strip 10 is such that a plurality of such strips become releasably interlocked when accumulated together (FIGS. 6a and 6b), such as when dumped into a shipping container. Specifically, a plurality of single faced corrugated strips move together as if coupled together although individual strips may be pulled apart with minimal—yet intentional—effort.

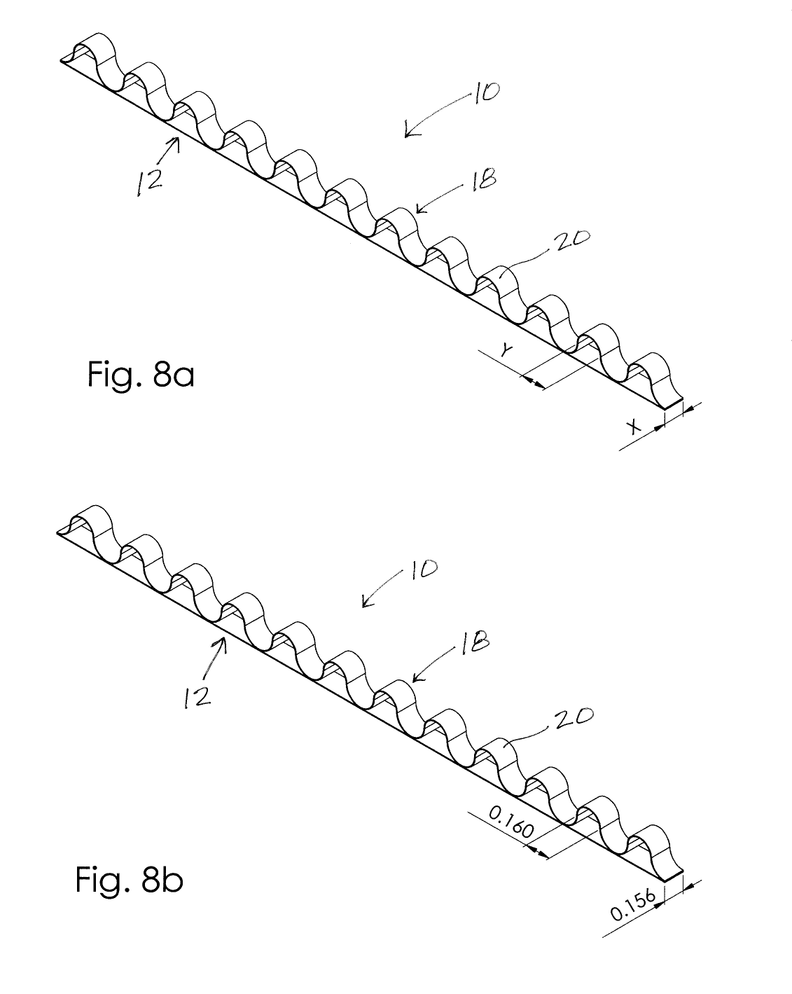

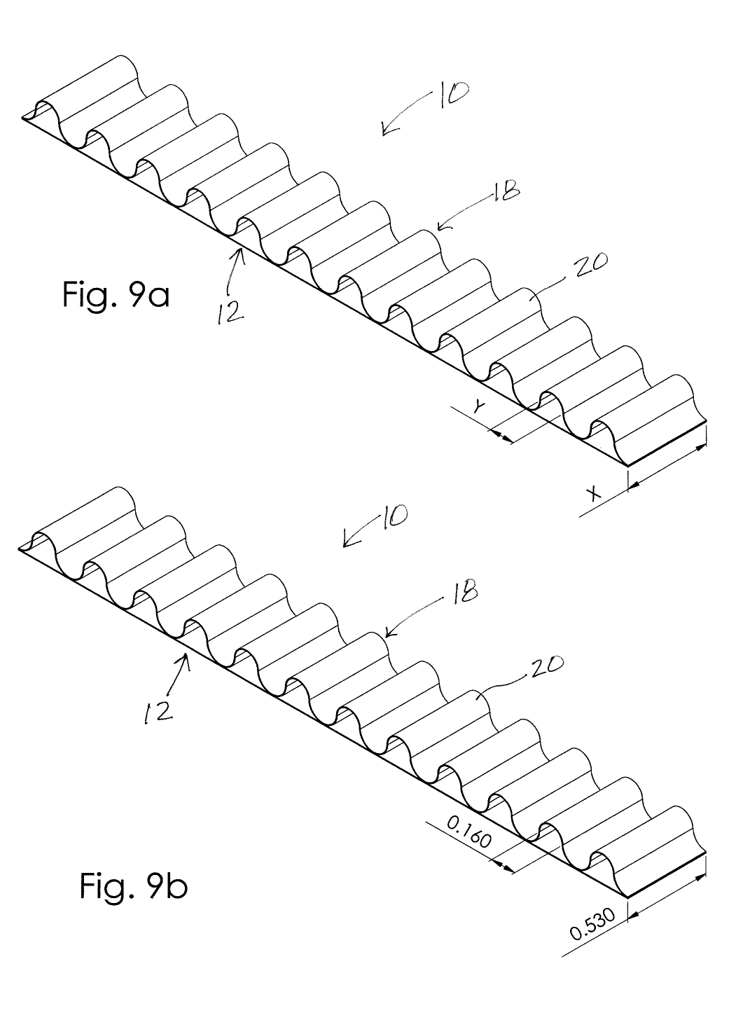

Importantly, there is a configuration of the elements described above that is critical to the interlocking of two or more corrugated strips 10 according to the present invention. More particularly, a width of a corrugated strip 10 is less than or equal to a distance between any two adjacent fluted elements 20. For the sake of illustration, the width of a corrugated strip is indicated by reference character “X” in FIGS. 8a and 9a. Similarly, the distance between adjacent fluted elements is indicated by reference character “Y” in FIGS. 8a and 9a. For instance, the width of the corrugated strip shown in FIG. 8b is 0.156 inches and the distance between adjacent fluted elements is 0.160 inches. Since 0.156 inches is less than or equal to 0.160 inches, two corrugated strips configured as illustrated in FIG. 8b will interlock efficiently. By contrast, the width of the corrugated strip 10 illustrated in FIG. 9b is 0.530 inches which is not less than the distance 0.160 inches between adjacent fluted elements 20. It should be clear in viewing FIG. 9b that two identical strips would not interlock efficiently in the manner shown in FIG. 6b.

With specific reference to FIG. 6b, it should be observed that the most efficient and natural interlocking occurs when the fluted elements 20 face one another and two strips are oriented generally perpendicular to one another. This is because the relationship of the width X of respective corrugated strips 20 being less than the distance Y between adjacent fluted elements 20 is most complementary and pronounced in this orientation. It is understood that this interlocking will occur randomly when a plurality of strips are essentially dumped together as loose fill packaging.

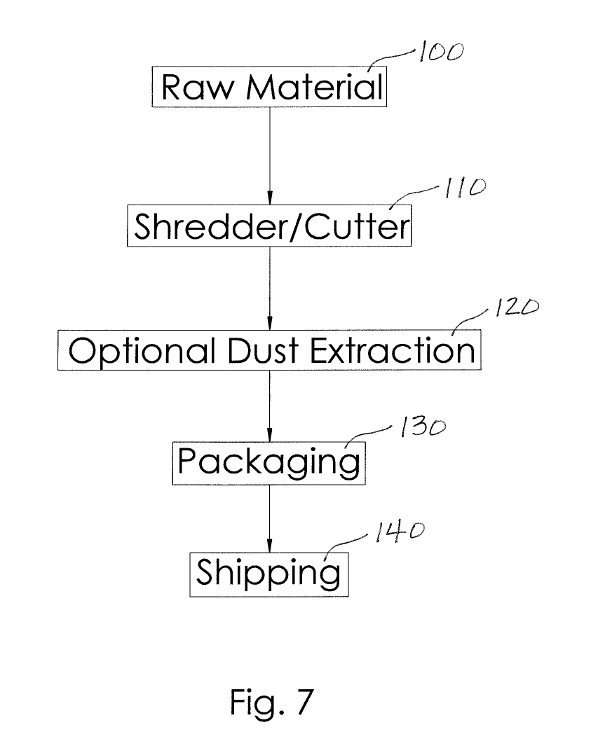

The present invention includes a method for making a loose fill packaging material consisting of a plurality of discrete loose fill packaging members having the characteristics and construction described above. FIG. 7 illustrates the major steps of the method. Specifically, the method of making loose fill packaging includes providing an entire sheet or sheets of single faced corrugated material. Sheets of corrugated material may be obtained from paper mills specifically coordinated to make such product and the corrugated material may be made from recycled or virgin paper stock of predetermined thickness. The step of obtaining the raw materials is identified in FIG. 7 with reference numeral 100.

Next, the plurality of single faced corrugated strips 10 may be cut out from the sheet of corrugated material, as indicated at step 110. The manner in which a strip 10 is cut is important to the characteristics and effectiveness of the corrugated strip. In general, the strips are first cut longitudinally in parallel with the imaginary longitudinal axis of the eventual strip 10. Accordingly, long strips 10 having a predetermined width may be cut first from an entire sheet of single side corrugated material. Then, a second cutting is made to the elongate strips. The second cutting is perpendicular to the imaginary longitudinal axis of respective strips. The second cutting effectively defines the predetermined length of each strip. A specially configured cutting machine (not shown) may be utilized for making the cuts described above and may be referred to as a shredder.

It is understood that in another embodiment, the strips 10 may first be cut perpendicular to the imaginary longitudinal axis. Then, the second cut may be made longitudinally in parallel to the longitudinal axis of the eventual strip 10. As stated above, the order of the cutting may affect the characteristics and effectiveness of the corrugated strips 10.

The process of shredding or cutting the plurality of single faced corrugated strips 10 may cause an undesirable or unacceptable amount of dust and is considered a “dirty” process. Accordingly, a method step 120 of dust extraction may be included in the present method so as to completely remove or at least significantly reduce the amount of dust in the process or that would otherwise remain on the corrugated strips 10. Dust extraction may be carried out by vacuum or other specialty extraction equipment.

Once cut to a predetermined size and optionally “cleansed” from dust and residue, the plurality of single faced corrugated strips may be used as loose fill packaging around articles that need to be held still and undamaged in shipping. A plurality of strips 10 may be inserted into a box or other packing container, as indicated at step 130. The items to be shipped may then be nestled into the packaging material followed by the remainder of the container being filled with more of the corrugated strips 10. The container may then be sealed and shipped, as indicated at step 140.

The efficacy of the single faced corrugated strips 10 has been tested and shown to be superior over any other type of loose fill packaging material even remotely in its inexpensive price range. Side by side tests were conducted using containers of identical size, weight, material, and article to be shipped with the only difference being the type of loose fill material. In each test, the containers were filled with loose packaging material and an article to be protected and shipped. Then, the containers were vibrated/shaken for a predetermined amount of time before the position and condition of the article was inspected. In one test, in particular, one container was filled with foam “peanuts” and another filled with single faced corrugated strips 10 as described above. An egg was placed generally in the center of each container surround tightly with the respective packaging material. After vibrating for a period of time, the egg in the container of “peanuts” had migrated to the bottom and was broken. A similar test was performed using double faced corrugated loose fill packaging material with a very similar result—the egg was broken. The egg in the container of single faced corrugated strip had not moved substantially and was unbroken.

These tests were repeated with a heavy steel ball as the item representing an article to be shipped. While there was obviously no breakage of the steel ball, the ball migrated quickly to the bottom of the shipping container in the case of the peanuts and double faced corrugated material. However, migration of the ball in the box containing single faced corrugated strips 10 was minimal.

It is understood that while certain forms of this invention have been illustrated and described, it is not limited thereto except insofar as such limitations are included in the following claims and allowable functional equivalents thereof.

1. A migration resistant loose fill packaging material, comprising:
a plurality of single faced corrugated strips, each single faced corrugated strip including:
a single liner member having an elongate and generally planar configuration, said single liner member having an upper surface and an opposed lower surface;
a corrugation portion having a plurality of connected fluted elements bonded to said upper surface of said single liner member.

2. The packaging material as in claim 1, wherein:
said lower surface of said liner member includes a generally linear configuration and smooth surface; and
said corrugated portion includes a generally wavy configuration.

3. The packaging material as in claim 2, wherein said single liner member has a semi-rigid construction that normally maintains a straight configuration.

4. The packaging material as in claim 1, wherein each fluted element has a generally inverted U-shaped configuration.

5. The packaging material as in claim 1, wherein said fluted elements of said corrugation portion of one corrugated strip releasably interlocks with respective fluted elements of at least one other corrugated strip.

6. The packaging material as in claim 1, wherein said each corrugated strip defines an imaginary longitudinal axis, each said fluted element defining opposed open ends situated perpendicular to said imaginary longitudinal axis.

7. The packaging material as in claim 1, wherein said each corrugated strip has a length of about 102 mm and a width of about 4 mm.

8. The packaging material as in claim 7, wherein said corrugated member is an A, B, C, or jumbo flute corrugated material.

9. The packaging material as in claim 1, wherein said corrugated member is an A, B, C, or jumbo corrugated material.

10. The packaging material as in claim 2, wherein said corrugated member is an A, B, C, or jumbo flute corrugated material.

11. The packaging material as in claim 1, wherein said corrugated member is biodegradable.

12. The packaging material as in claim 1, wherein said corrugated member is static free.

13. The packaging material as in claim 1, wherein said corrugated member is mildly flexible yet resilient.

14. The packaging material as in claim 1, wherein a width of a respective single liner member is equal to or less than a distance between any two adjacent fluted elements of said corrugated portion.

15. The packaging material as in claim 5, wherein a width of a respective single liner member is equal to or less than a distance between any two adjacent fluted elements of said corrugated portion.

16. The packaging material as in claim 7, wherein a width of a respective single liner member is equal to or less than a distance between any two adjacent fluted elements of said corrugated portion.

17. A method for making a loose fill packaging material consisting of a plurality of discrete loose fill packaging members, said method including the steps:
providing a sheet of single faced corrugated material;
cutting said sheet into a plurality of single faced corrugated strips, each corrugated strip having a single liner member having an elongate and generally planar configuration and a corrugation portion having a plurality of connected fluted elements bonded to said upper surface of said single liner member; and
cutting said loose fill packaging members from said plurality of single faced corrugated strips.

18. The method for making a loose fill packaging material as in claim 17, wherein each said corrugated strip defines an imaginary longitudinal axis, said method for making a loose fill packaging material further comprising:
first cutting said sheet into said corrugated strips by cutting along respective imaginary longitudinal axes; and
second cutting said corrugated strips into said plurality of loose fill packaging members by cutting perpendicular to said respective imaginary longitudinal axes.

19. The method for making a loose fill packaging material as in claim 18, wherein:
said single liner member of said each corrugated strip includes a generally linear configuration and smooth surface; and
said fluted element of each said corrugated strip has a generally inverted U-shaped configuration.

20. The method for making a loose fill packaging material as in claim 17, wherein each said corrugated member is an A, B, C, or jumbo flute corrugated material.
